(19) United States
(12) Patent Application Publication
(10) Pub. No.: US 2016/0253833 A1
(43) Pub. Date: Sep. 1, 2016

(54) SYSTEM AND METHOD FOR PHOTO ALBUM JOURNALING

(71) Applicant: Grace Lew, Encino, CA (US)

(72) Inventor: Grace Lew, Encino, CA (US)

(21) Appl. No.: 14/961,714

(22) Filed: Dec. 7, 2015

Related U.S. Application Data
(60) Provisional application No. 62/121,316, filed on Feb. 26, 2015.

(51) Int. Cl. G06T 11/60; H04N 1/00; G06F 17/24

(52) U.S. Cl. CPC G06T 11/60; G06F 17/248; H04N 1/00167; H04N 1/00196; H04N 1/00177

(57) ABSTRACT

This invention provides a method for automatically creating a photo album, the method comprising the steps of selecting a pre-designed photo album template alleviating the need for any other design work by a user, the photo album template comprising one or more pages of the photo album; automatically capturing a plurality of images, videos and text journaling in one or more pages of the photo album within the photo album template chronologically and in real time and having the time, date and optional location stamped under each entry; adding image and metadata associated with the plurality of images to the one or more pages of the photo album chronologically; and storing a completed photo album on a storage media.

### CROSS-REFERENCE TO RELATED APPLICATIONS

The present Application claims the benefit of U.S. Provisional Patent Application No. 62/121,316 titled “System and Method for Photo Album Journaling,” filed Feb. 26, 2015, the contents of which are incorporated herein by reference in their entirety.

### BACKGROUND

Traditional methods of documenting personal or family history include compiling photo albums with printed photos, writing journals by hand, and taking home videos. However, these traditional methods are time consuming, expensive, and inconvenient. As an example, a traditional photo album requires consumers to take photos, print the photos, purchase a photo album, and physically arrange the photos in the album. A more complex photo album, such as a scrapbook, requires additional expensive supplies. Often, in addition to the printed photos, the pages of scrapbooks contain graphic, electronically printed designs and embellishments with crafting elements such as ribbon, ornamental tape, stamps, stickers, and buttons. Traditionally, journals require the author to physically put pen to paper. Taking traditional home videos requires specialized equipment including camcorders, digital storage devices, and editing software.

Recently, due to the wide-spread use of personal, portable, and mobile electronic devices such as a smartphone or tablet, it has become common for a user to capture and store photos, text memos and messages, and videos on such mobile devices. Several online or web-based programs or applications such as Shutterfly have been developed which enable a user to create a digital photo album which can then be printed in hard copy. These programs allow the user to customize and create photo-based projects.

However, these programs have various drawbacks. One drawback is the amount of time required by a user to create a photo album. The programs require the user to choose the photographs to be included in a photo album, to group photos by occasion, edit the photos such as by cropping the photos to focus on a relevant subject, as well as resizing or reorienting the photos or moving photos around so they follow the order in which the photos were taken. Many programs require that the photo editing be done in a separate program, which is also time-consuming. A user has to be somewhat of a graphics designer in order to make the process faster because there is some designing needed within these Apps to get the cover of the album properly customized and designed and if the user would like to add comments and or text, the user must then do so as the user is editing the album. Yet another drawback is that these programs do not allow the user to create a photo album entirely on a mobile electronic device. For example, U.S. Pat. No. 8,923,551 to Grosz et al. allows a user to apply the user's own digital photos in various orientations on digitally rendered scrapbook pages. Once designed, the digital pages may even be printed for presentation in a book. An enhancement over U.S. Pat. No. 8,923,551 is U.S. Pat. No. 8,958,662 to Grosz et al., which allows the user to apply additional crafting elements, such as stickers, photo frames, and apparent paper texture to the photo album pages in digital form. However, U.S. Pat. No. 8,958,662 is limited to implementation on a traditional personal computer, not a mobile electronic device.

The current methods and systems for digitally preserving personal and familial history are deficient for several reasons. First the user must sit down to a personal computer and or mobile phone, sift through the user's inventory of digitally accumulated photos, arrange the selected photos on a page and or into a digital album, and digitally embellish the pages of the digital album. Users find this step prohibitively time-consuming and inconvenient.

Second, the current methods and systems for digitally preserving personal and family history require the user to combine the albums with hand-written or digital journals, or insert descriptive text in relation to each photo. Again, users find this step time-consuming.

Additionally, the current methods and systems do not offer the ability to add home videos to the digital album and printed album. The addition of home videos would make an album fully complete at saving all of life's most precious memories. Moreover, the current methods do not help the user to archive and save all photo, text, and video entries in a chronological and organized manner for future use and ease of locating old photos, videos and text entries. Indeed, many users find the effort of tracking down and preserving such documentation too much of a hassle to bother with at all and in turn risk losing the memories forever.

Thus, there is a need for a system, method, and apparatus to compile photos, journal entries, and home movies into a single, categorized, chronological and unified volume. There is a further need for a system and method for creating an album in real-time, as the photos and home movies and text journaling or thoughts are captured concurrently as the events giving rise to the journal entries occur.

Moreover, there is a need for a system, method, and apparatus which regularly provides the user with one or more physical copies of the digitally created photo albums and journals, accompanied by a digital copy of any home movies corresponding to such albums and journals. Finally, there is a need for a system and method that allows a user to easily duplicate and share any digitally created photo albums, journals, and home videos with family, friends, and others in print and/or electronic form.

### SUMMARY

The present invention is a method for automatically creating a photo album, wherein the method comprises the steps of: a) selecting a pre-designed photo album template by a user, the photo album template comprising one or more pages of the photo album; b) automatically and chronologically stamping and placing in real time a plurality of images in one or more pages of the photo album within the photo album template; c) adding image and metadata associated with the plurality of images to the one or more pages of the photo album in real time; and d) storing a completed photo album on a storage media chronologically.

Optionally, the photo album template comprises a theme to accommodate a preset number of photos or a preset number of photo album pages and journal entries. Additionally, the plurality of images comprise one or more photographs or one or more videos. The storage media comprises one or more of the following: non-writable storage media, writable storage media, or communications media.

The method can further comprise the step e) sharing the photo album with one or more users. Optionally, a plurality of photo albums are automatically created simultaneously.

In a second embodiment of the present invention, the present invention comprises a method of creating a photo album, wherein the method comprises the steps of: a) creating an account; b) ability to create one or more photo albums; c) saving a plurality of photographs to the selected photo albums by one or more users; d) automatically organizing the plurality of photographs, text entries and video entries chronologically; e) adding text or auto text in real time by the one or more users; f) adding one or more videos to the selected photo album; g) uploading the one or more photo albums to a server automatically; and h) printing the one or more photo albums at a predetermined time.

Optionally, the method can further comprise the step i) editing the photo album, wherein step i) follows step f), and is before step g). Additionally, step i) comprises editing text. Optionally, step i) comprises editing one or more photos in the selected photo album.

### DRAWINGS

These and other features, aspects and advantages of the present invention will become better understood with regard to the following description, appended claims, and accompanying figures where:

FIG. 1 shows the present invention being run on an electronic device.

FIG. 2 is a network configuration diagram in which the present invention may be practiced.

FIG. 3 is a flow diagram showing a method of using the present invention.

FIG. 4 shows a front plan view of a cellular phone having a touch screen that includes the present invention described herein.

FIG. 5 shows a front plan view of the cellular phone of FIG. 3, wherein the step of creating an account is being performed.

FIG. 6 shows a front plan view of the cellular phone of FIG. 3, wherein the step of creating an album is being performed.

FIG. 7 shows a front plan view of the cellular phone of FIG. 3, wherein the step of sharing an album with other users is being performed.

FIG. 8 shows a front plan view of the cellular phone of FIG. 3, wherein the step of selecting an album style is being performed.

FIG. 9 shows a front plan view of the cellular phone of FIG. 3, wherein the selected album style is integrated into the album.

FIG. 10 shows a front plan view of the cellular phone of FIG. 3, wherein the step of selecting an album title is being performed.

FIG. 11 shows a front plan view of the cellular phone of FIG. 3, wherein the step of uploading a first photo to the album is being performed.

FIG. 12 shows a front plan view of the cellular phone of FIG. 3, wherein the step of captioning the uploaded photo is being performed.

FIG. 13 shows a front plan view of the cellular phone of FIG. 3, wherein the step of uploading a second photo is being performed.

FIG. 14 shows a front plan view of the cellular phone of FIG. 3, wherein the album has multiple photos uploaded to it.

FIG. 15 shows a front plan view of the cellular phone of FIG. 3, wherein the album is full of photos, and user can select the ability to edit the photos.

FIG. 16 shows a front plan view of the cellular phone of FIG. 3, wherein the photos in the album can be selected, and then the user can choose to edit of purchase the selected photos.

FIG. 17 shows a front plan view of the cellular phone of FIG. 3, wherein the step of creating a milestone is being performed.

FIG. 18 shows a front plan view of the cellular phone of FIG. 3, wherein the album is full and the user has the ability to select the purchase function.

FIG. 19 shows a front plan view of the cellular phone of FIG. 3, wherein the album is full and the user has the ability to select the purchase of a DVD of videos taken within the first photo entry to the last entry of the selected album function.

FIG. 20 shows a front plan view of the cellular phone of FIG. 3, wherein after a user has selected to purchase an album, a confirmation page is displayed to confirm the purchase.

FIG. 21 shows a front plan view of the cellular phone of FIG. 3, wherein after the user has confirmed the purchase of an album, a final confirmation page is displayed providing the estimated delivery time.

### DESCRIPTION

As used herein, the following terms and variations thereof have the meanings given below, unless a different meaning is clearly intended by the context in which such term is used.

The terms “a,” “an,” and “the” and similar referents used herein are to be construed to cover both the singular and the plural unless their usage in context indicates otherwise.

As used herein, the term “comprise” and variations of the term, such as “comprising” and “comprises,” are not intended to exclude other additives, components, integers or steps.

The terms “couple,” “coupled,” “couples,” and “coupling,” refer to connecting two or more elements or signals electrically, mechanically, or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent, semi-permanent, or only for an instant.

“Image” or “photo” refers to a digital or print image.

The terms “photo album,” “digital album,” “photo book,” or “scrapbook” means any type of media-based project, in digital or print form. A photo album may be printed on paper and bound together as a book.

“Media files” refers to audio files, video files, text files, or image files.

Embodiments of the present invention relate to applications, methods, and systems for creating media-based projects, such as a photo album.

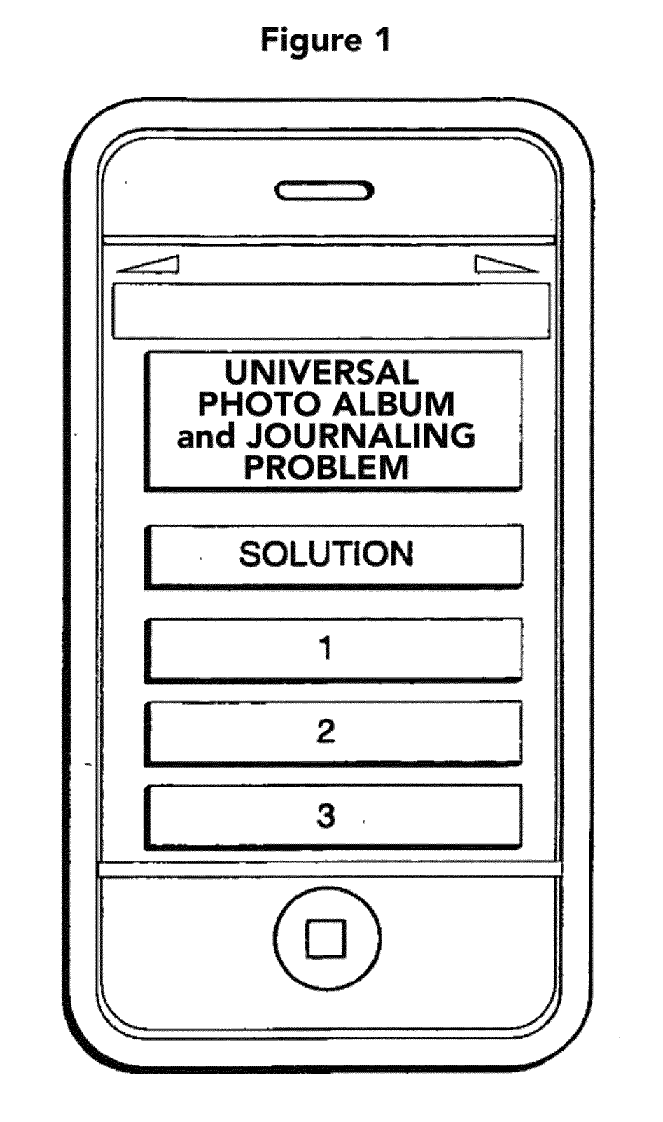

The present invention is directed to a program or application that is run on an electronic device. The application is concerned with creating a digital volume containing a compilation or album with photos, a journal, and home videos, as well as providing the photo album and journal in the form of a bound, physical album with an accompanying digital copy of the home videos and photos contained in the album. FIG. 1 shows the program or application of the present invention being run on an electronic device.

The photos can be taken by one or more users and stored within the memory of each user's electronic device. The photos can also be stored on a remote network or server. Any unwanted or poor quality photos are unselected by the user. The user can edit the photos for brightness or color via their photo application and then replace them.

The text of the journal can be input directly by the user, or it may be automatically populated by the use of facial-recognition software, object-recognition software, or from the photo's meta-data, which includes date and location.

The home videos may together comprise a video log, video diary, or other short film or video taken to record and preserve experiences, activities, and special events.

It is contemplated that the one or more digital volumes may be compiled in real-time, as the photos and home videos are taken, or as events giving rise to the journal entries occur, as described further below. In one aspect of the present invention, the digital volume is created automatically by the application as photos are taken by the user. In another embodiment, the digital volumes may be compiled at the user's leisure.

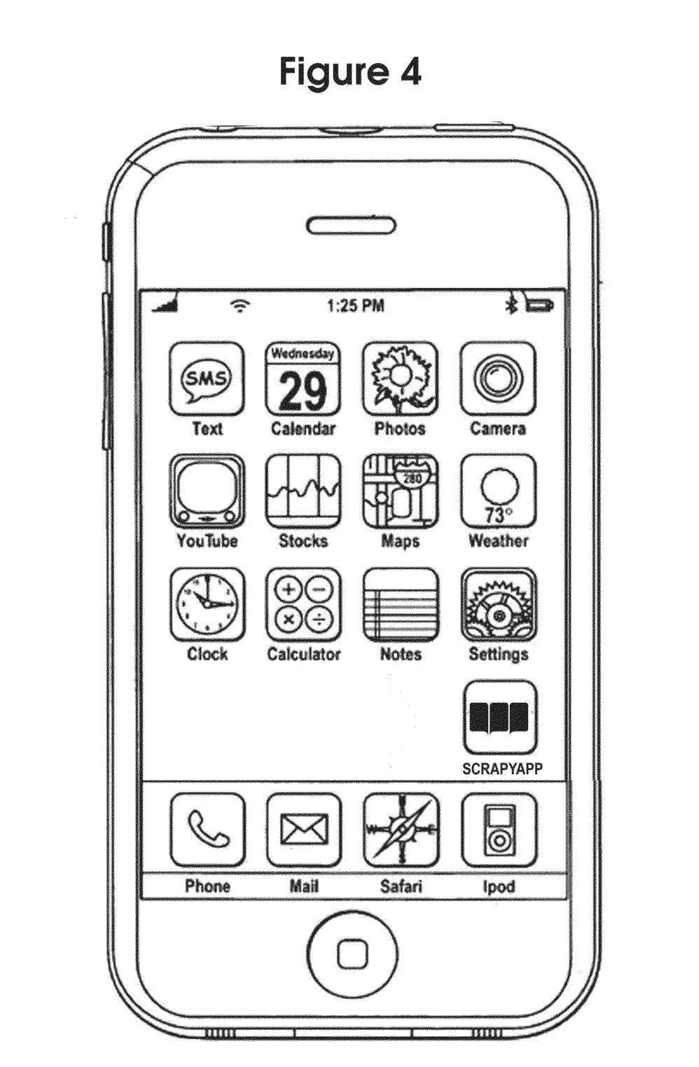

The program or application of the invention can be used in connection with an electronic device. The electronic device may be a mobile device such as a tablet computer, mobile computer or smartphone, but may also be embodied in any one of a wide variety of wired and/or wireless computing devices. FIG. 4 depicts the use of the program or application with a smartphone. The electronic device includes a processing device (processor), input/output interfaces, a display, a network interface, a memory, an operating system, and storage. The electronic device may also include a touchscreen interface for ease of use, and a global positioning system (GPS) communicating across a local data bus.

The electronic device incorporates a system containing the program or application for creating a digital volume.

The processing device may include any custom-made or commercially available processor, a central processing unit (CPU), or an auxiliary processor among several processors associated with the electronic device, a semiconductor based microprocessor (in the form of a microchip), a macroprocessor, one or more application specific integrated circuits (ASICs), a plurality of suitably configured digital logic gates, and other electrical configurations comprising discrete elements both individually and in various combinations to coordinate the overall operation of the system.

The memory can include any one of a combination of volatile memory elements (e.g., random-access memory (RAM, such as DRAM, and SRAM, etc.)) and nonvolatile memory elements. The memory typically comprises native operating system, one or more native applications, emulation systems, or emulated applications for any of a variety of operating systems and/or emulated hardware platforms, emulated operating systems, etc.

The invention may include application specific software, which may comprise some or all the components of the electronic device. In accordance with such embodiments, the components are stored in memory and executed by the processing device. The system and method for digital scrapbooking may be resident in the memory of the electronic device.

In one aspect of the invention, the touchscreen interface is configured to detect contact within the display area of the display, and provides such functionality as on-screen buttons, menus, keyboards, etc. that allows a user to navigate user interfaces by touch. More particularly, user interfaces navigable by touch may be configured to allow users to access digital photo albums, select photos from the photo album, apply and configure selected photos on individual scrapbook pages, and arrange digital embellishments on the individual scrapbook pages. Of course, such user interfaces are offered by way of example and not of limitation.

In another aspect of the invention, the electronic device has a Global Positioning System (GPS) or other means to determine the geographical location of the electronic device. This may allow the user or the application to efficiently determine the time and location that particular events were captured. This information may be automatically incorporated into the visible body of the scrapbook page.

One of ordinary skill in the art will appreciate that the memory can, and typically will, comprise other components that have been omitted for purposes of brevity. In the context of this disclosure, a non-transitory computer-readable medium stores one or more programs for use by or in connection with an instruction execution system, apparatus, or device.

An electronic device network interface may comprise various components used to transmit and/or receive data over a networked environment. When such components are embodied as an application, the one or more components may be stored on a non-transitory computer-readable medium and executed by the processing device.

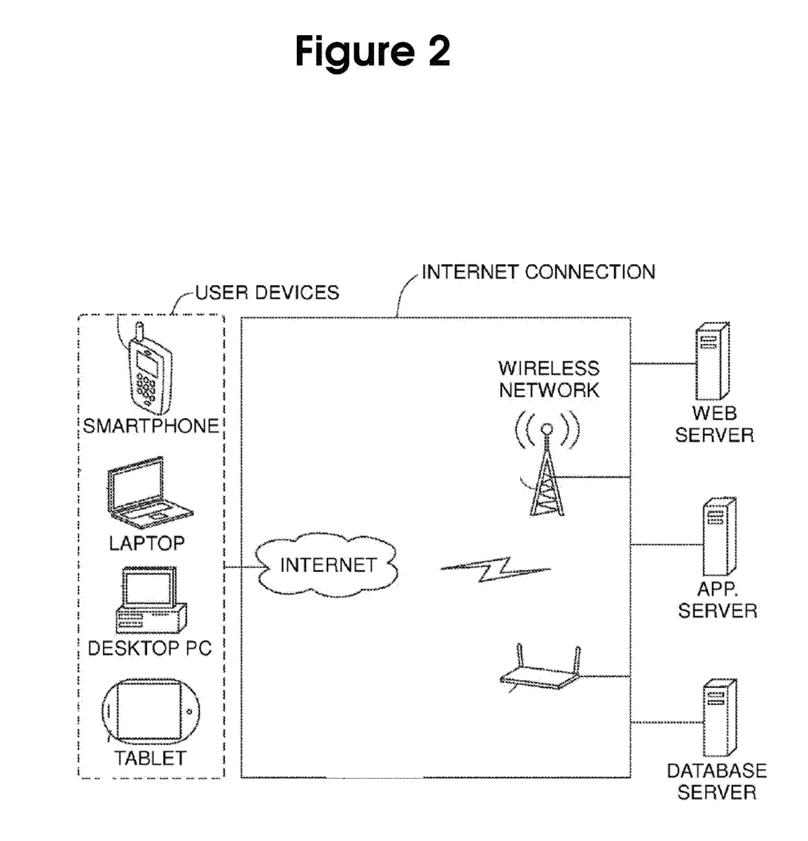

In one aspect, the invention comprises the networked environment of the system and method for digital scrapbooking. For example, multiple electronic devices may be communicatively coupled via a communication network, as shown in FIG. 2. By way of example and not limitation, each of the electronic devices may be embodied as a mobile computing device such as, for example and without limitation, a smartphone, as illustrated in FIGS. 1-20, or a tablet computer that incorporates cellular telephone functionality. The communications network can use one or more of various communications types such as, for example and without limitation, cellular and Wi-Fi communications.

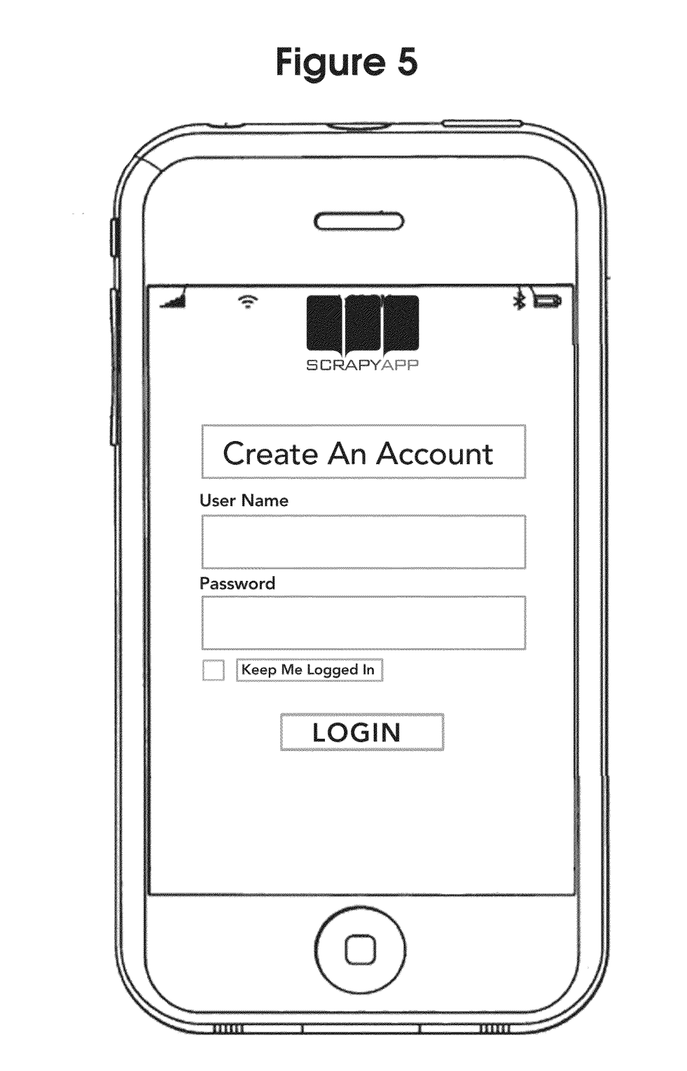

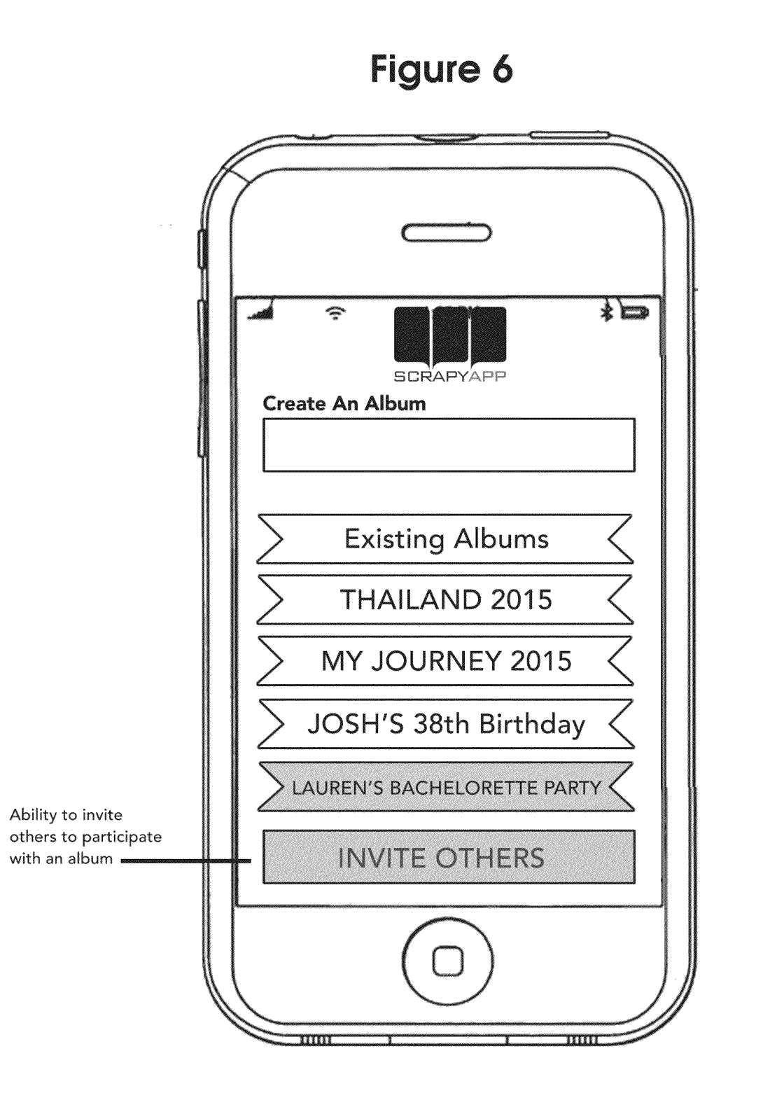

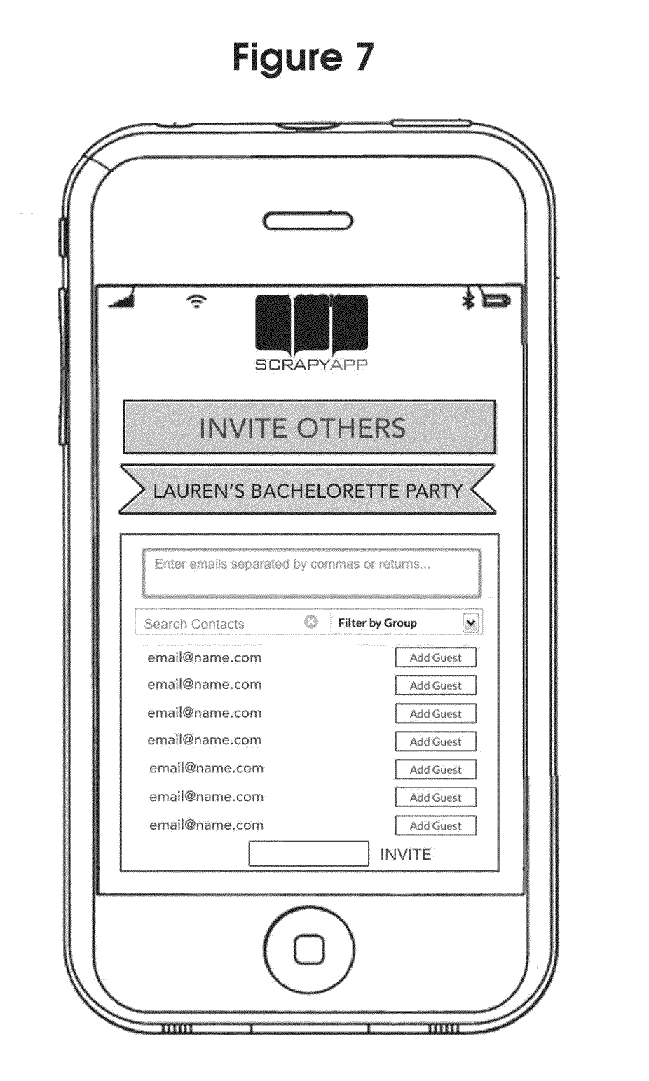

The first step a user will engage in is creating an account, as shown in FIG. 5. Next, the user will create a photo album, as shown in FIG. 6. The user will also have the ability to invite other users to access the photo album, as shown in FIG. 7. The user can allow selected guests within their contact list to participate and contribute photographs, text and video entries.

It is contemplated that the application of the invention may instruct the electronic device to access a digital photo album. The digital photo album may be stored on the electronic device such as in an image galley or library typically stored in a memory portion of exemplary electronic devices.

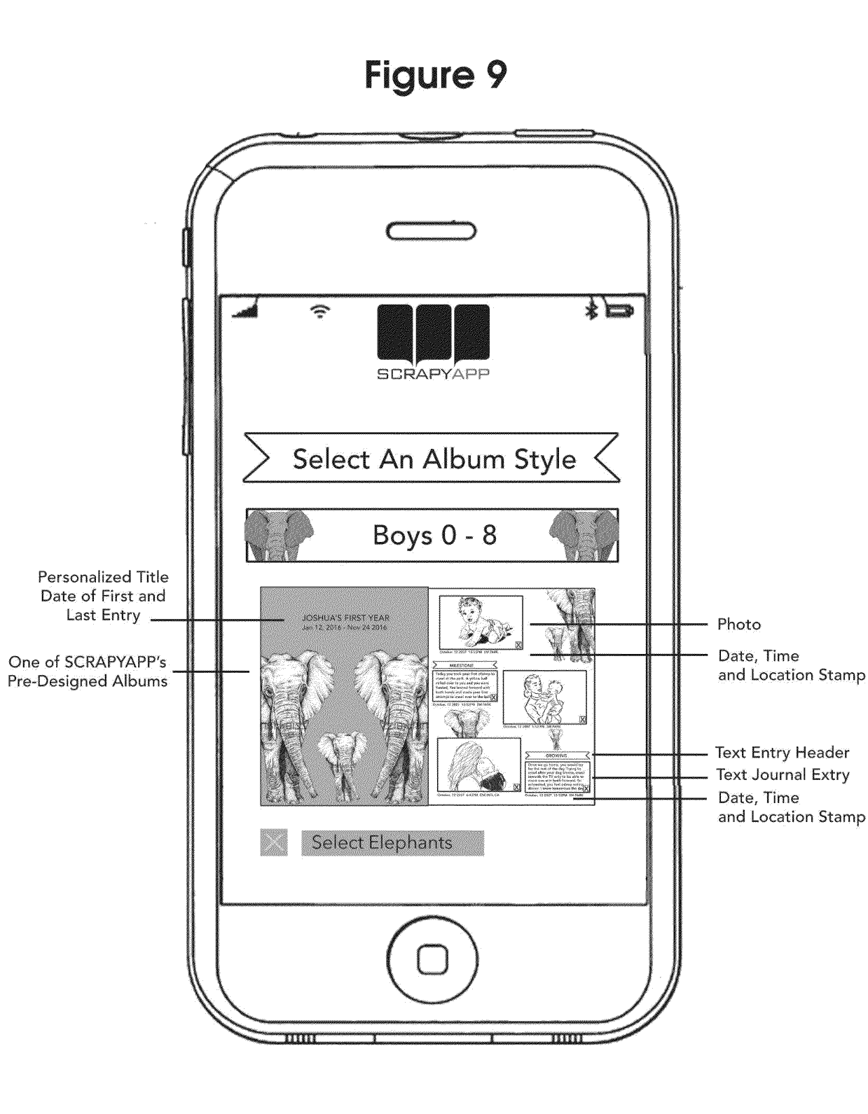

Having accessed the digital photo album, the device may be instructed to include one or more of the photos therein on one or more digital photo album pages. The system may further prompt the user to provide a detailed description, or journal entry, for each of the selected photos. For example, the journal entry may comprise one or more labels including the date each photo was taken, the location where each photo was taken, the context the photo was taken in, or other comments that the user wishes to include with the photo, as shown in FIG. 9.

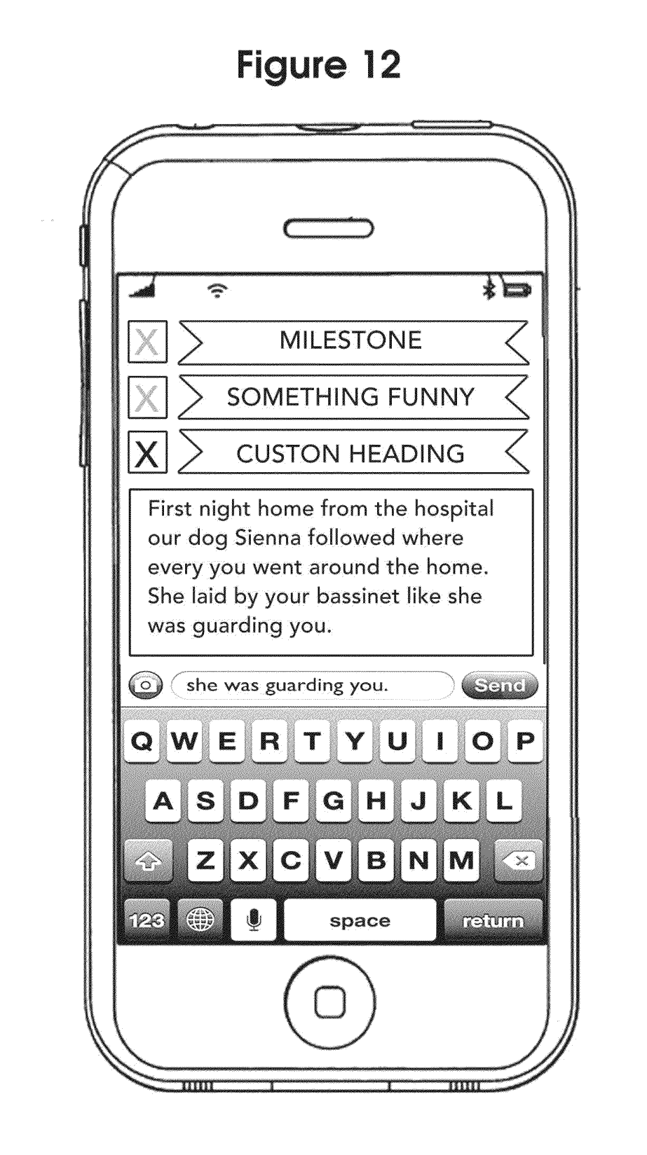

In one aspect of the present invention, the date and location information related to a particular photo may be stored in any digital metadata associated with the photo, and the device may automatically incorporate this information into the journal entry relating to the photo. In other words, the system may be configured to automatically include text that indicates where and when a photo, video, and/or journal entry was made on each digital photo album page. This is shown in FIG. 9. In another embodiment, the user may be prompted to manually type or otherwise indicate the particular context of each selected photo, for example, whether the photo relates to a milestone or accomplishment, a humorous happenstance, or any other description a user deems appropriate, as shown in FIG. 12.

One aspect of the present invention is implemented as a program, application, or product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; and (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

If embodied in software, each step in the method of making a digital scrapbook or album may comprise program instructions stored on a non-transitory computer readable medium to implement the specified logical function(s). In this regard, the program instructions may be embodied in the form of source code that comprises statements written in a programming language or machine code that comprises numerical instructions recognizable by a suitable execution system such as any of the aforementioned electronic devices. The machine code may be converted from the source code, etc. If embodied in hardware, each step of the exemplary methods may represent a circuit or a number of interconnected circuits to implement the specified logical function(s). Additionally, although the steps of the exemplary methods are discussed in specific orders of execution, it is to be understood that the orders of execution may differ.

The application of the invention may instruct the electronic device to access a digital video library comprising one or more home videos, video diaries, or other videos that may be stored in a memory portion of the electronic device. Any videos chosen from such a video library may be related in time, subject, location, or context to the aforementioned photos and journal entries and may also be accompanied by journal entries as described above.

In general, the routines executed to implement the embodiments of the invention may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

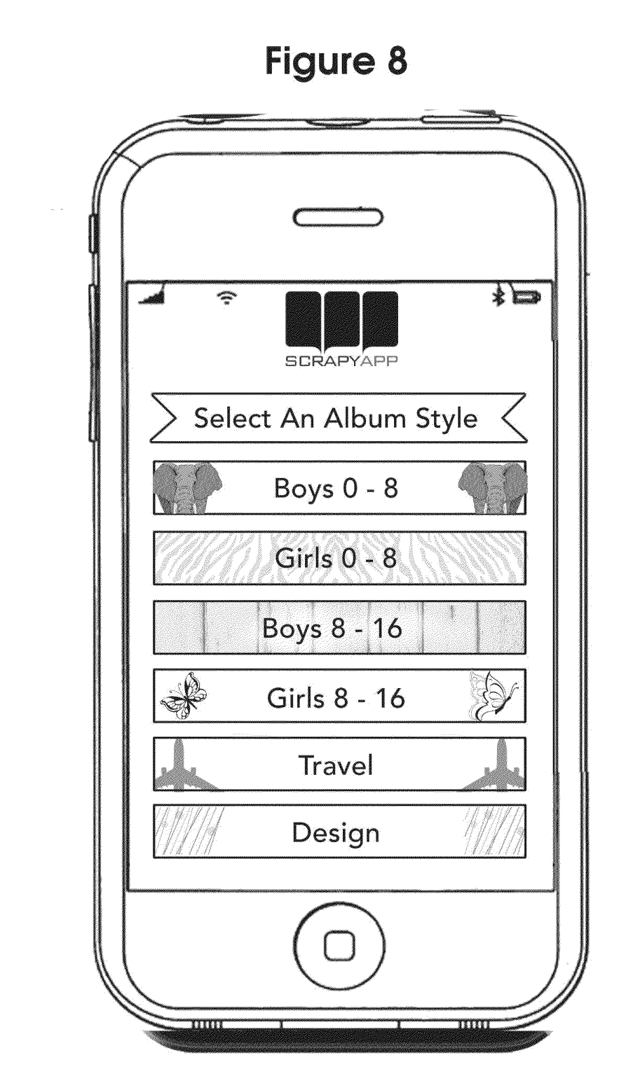

It is contemplated that the digital album of the invention combines aspects of a photo album, journal, and various home videos which may be created chronologically so that all, or a variety of user selected, photos and videos captured within a specified time period are included in the album. The electronic device may also receive instructions to configure one or more photos accompanied by corresponding journal entries on one or more album pages. In one embodiment, a template optionally containing a theme may be provided to accommodate a preset number of photos and/or a preset number of album pages and journal entries, as shown in FIGS. 8-10. In another embodiment, the template may place the photos in a predetermined configuration on each of the album pages. In yet another embodiment, a template may be provided to accommodate journal entries within a predetermined character count. It is also contemplated that the electronic device automatically populates album page templates with photos and journal entries including information from the metadata of each photo. Use of the metadata of the photo is advantageous because the user may not remember where or when the photo was taken.

The present invention offers a selection of predesigned albums with no need for any other embellishments or designing on the user's side. All the design work has been done for the user. The user just has to point and shoot, make text entries and record video straight into the selected album and the album is created in real time. This makes the albums even more special and easier to create.

It is further contemplated that the number and arrangement of photos, number of scrapbook pages, and length of any detailed descriptions may be uniquely specified by the user. In this manner, the resulting photo album may be completely customized by the user.

The application of the invention allows the user to efficiently preserve the user's personal or family history as events occur in a digitally created scrapbook. This digitally created scrapbook provides viewers a more accurate sense of the history surrounding the subjects of the combined photos, journals, and home videos. Moreover, it may relieve the user of the difficulty associated with compiling photos and videos, as well as drafting captions to describe the photos and videos.

It is also contemplated that the application may receive instructions to create multiple photo albums simultaneously. For example, if a parent would like to create a photo album for each of his or her two or more children, he or she may create a separate album, designated by a title of his or her choosing, for each child. Then, the user may direct photos, videos, and journal entries relating to each child to the child's respective album simultaneously as the user captures moments that he or she would like to preserve in the child's respective album. In addition to sorting by a person, it is contemplated that the application may be instructed to store multiple scrapbooks so that a user may create scrapbooks featuring certain events, people, stories, themes or any other reason they may wish to separate their photos, videos, and journal entries. In another embodiment, the digital photo albums may be created chronologically so that all, or a selection, of any photos captured within a specified time period are included in the scrapbook.

In one aspect of the invention, the application may store each photo album for a user to return to or complete at a later date. This may allow a user to include events in a scrapbook as they occur without any fear that prior pages or memories will be lost or otherwise inaccessible. The aforementioned steps may be repeated until various photos, journal entries, embellishments surrounding the photos and journal entries are presented in a series of digital pages. Such pages may also be accompanied by digitally captured home videos so that the user may be provided with a unified digital copy of related photos, journal entries, and videos.

Thus, it is an object of the invention to provide a user with complete control over the content and design of their digitally created photo album. It is an additional object of the invention to include journal entries as detailed descriptions for each of the photos included in the digitally created scrapbook. It is an even further object of the invention to deliver a physically printed copy of the digitally created photo album, journal, and home videos periodically or upon the occurrence of a predetermined event. It is still another object of the invention to provide printed copies of any digitally created scrapbooks to one or more third parties specified or selected by a user.

Also presented is a system comprising the application of the invention, an electronic device, a network, one or more servers, and a service provider. The service provider can be, for example, a commercial company that is in the business of printing books. The service provider may be instructed to provide a physical copy of the digital photo album with journal entries once a predetermined number of digital pages have been designed. For example, the system may be instructed to print a fifteen-page album. Thus, when photos, journal entries, and embellishments encompass fifteen printed pages, the system is instructed to print the digitally rendered pages and deliver them in the form of a bound, printed volume to the creator of the book. One skilled in the art will recognize that videos are not generally printed in still, frame-by-frame form as photos are. It is contemplated that any home videos accompanying the photos and journal entries in the album may be included with the printed volume in digital form. For example, a CD ROM, DVD, or thumb drive may be appended to the volume containing such home videos. In one embodiment, a digital copy, such as stored on a DVD, secure digital (SD) card, or thumb drive, of the digital photo album pages and journal entries may also be appended to the printed volume. It is also contemplated that, individual photos included in the printed volume may be included in digital form.

It is also contemplated that the system may be instructed to print and send a physical and digital copy of the combined photo album, journal and home videos after a specified amount of time has passed. For example, the system may be instructed to compile and send album pages and home videos at the end of a single month, every three months, or even every year. Of course, such prescribed time periods are offered only by way of example and not of limitation.

Additionally, the physical albums will automatically have on their covers and spines date stamps within the title, date of first entry and last entry supporting the organization of contents chronologically by date.

The system may also allow the user to share the combination photo album, journal, and home videos with friends, family members, and others. For example, the system may be instructed to send a printed volume, along with a digital copy of any home videos and copy of the album, of the digitally created album to any address associated with the friends, family, or others.

It is contemplated that the system may communicatively link the user with family, friends, and others in a social network embodied by the system and method for digital scrapbooking. Optionally, the digitally created photo album, journal, and compiled home videos may be shared on existing social networking websites such as Facebook® and Twitter®.

The server is made up of hardware and software to implement the instructions of the application as directed by a client. The client can be any device that the user is using, such as an electronic device, a laptop, or a desktop PC. In the present invention, a server implements the system and method for digital scrapbooking and facilitates sending digital and physical copies of any completed albums to the user and any members of the network associated with the completed scrapbooks. In order to facilitate the aforementioned functionality, various aspects may be performed by one or more of the aforementioned electronic devices. In one aspect, the electronic device is operative to perform, at least in part, an embodiment of the method for digital scrapbooking. This method may include, for example: accessing a digital photo album; selecting one or more photos from the photo album; receiving detailed descriptions comprising journal entries associated with each of the one or more selected photos; applying the one or more selected photos with their corresponding journal entries in a chosen configuration on a digital page; applying one or more design specifications as embellishments on the digital page; selecting home videos to include; repeating the prior steps until a variety of embellished photos and journal entries as well as home videos are presented on a predetermined number of digital pages; and delivering a printed volume including the photos and journal entries to one or more specified recipients with a digital copy, such as on a CD ROM, of the compiled home videos, digital album pages and/or individual photos included in the printed volume.

The invention also contemplates operation of a system that is operative to perform for a method of performing digital scrapbooking. This method may include, for example: accessing a digital photo album; selecting one or more photos from the photo album; receiving detailed descriptions comprising journal entries associated with each of the one or more selected photos; applying the one or more selected photos with their corresponding journal entries in a chosen configuration on a digital page; applying one or more design specifications as embellishments on the digital page; selecting home videos to include; repeating the prior steps until a variety of embellished photos and journal entries as well as one or more home videos are presented on a predetermined number of digital pages; printing the digital pages; and delivering a printed volume including the photos and journal entries to one or more specified recipients with a digital copy, such as on a CD ROM containing the home videos, digital album pages and/or individual photos included in the printed volume.

It is also contemplated that users of the application of the invention may create their own private social network centered on a particular combination of photos, journal entries and home videos. For example, in one aspect of the invention, an album that memorializes a celebratory gathering, such as a wedding, might include each of the guests of the wedding as part of the social network. As another example, the album may depict images and events associated with a newborn's first months, and the social network may comprise the newborn's close relatives and friends of the newborn's parents. Indeed, the social network may comprise any such family members, friends, or others who may be particularly concerned with preserving memories reflected in a scrapbook.

The social network may enable members to use their electronic devices to interact with each other and may further enable multiple parties to receive and view digitally created albums including photos, journal entries, and home videos. Typically, a social network is facilitated by a website that may require a registration and login prior to use. However, regardless of how such a social network is implemented (be it web-based or not), the functionality of concern involves the ability to provide interaction among a limited group of members, as may be established by the members themselves. In another example, once an album is completed, the user who created it may instruct the system to send a digital or print copy of the photos and journal entries, accompanied by a digital copy of any included videos, to each family member, friend, or others included in the social network associated with that particular album.

In another aspect of the invention, the digital or print copies of a completed scrapbook may be sent to a family member, friend, or others independent of his or her membership in the social network. For example, a user may instruct the system to send digital or print copies of the album to one or more family members, friends, or other associates by uploading an address to the system.

### EXAMPLES

### Example 1

### A Method of Using the Program or Application Installed on a Smartphone

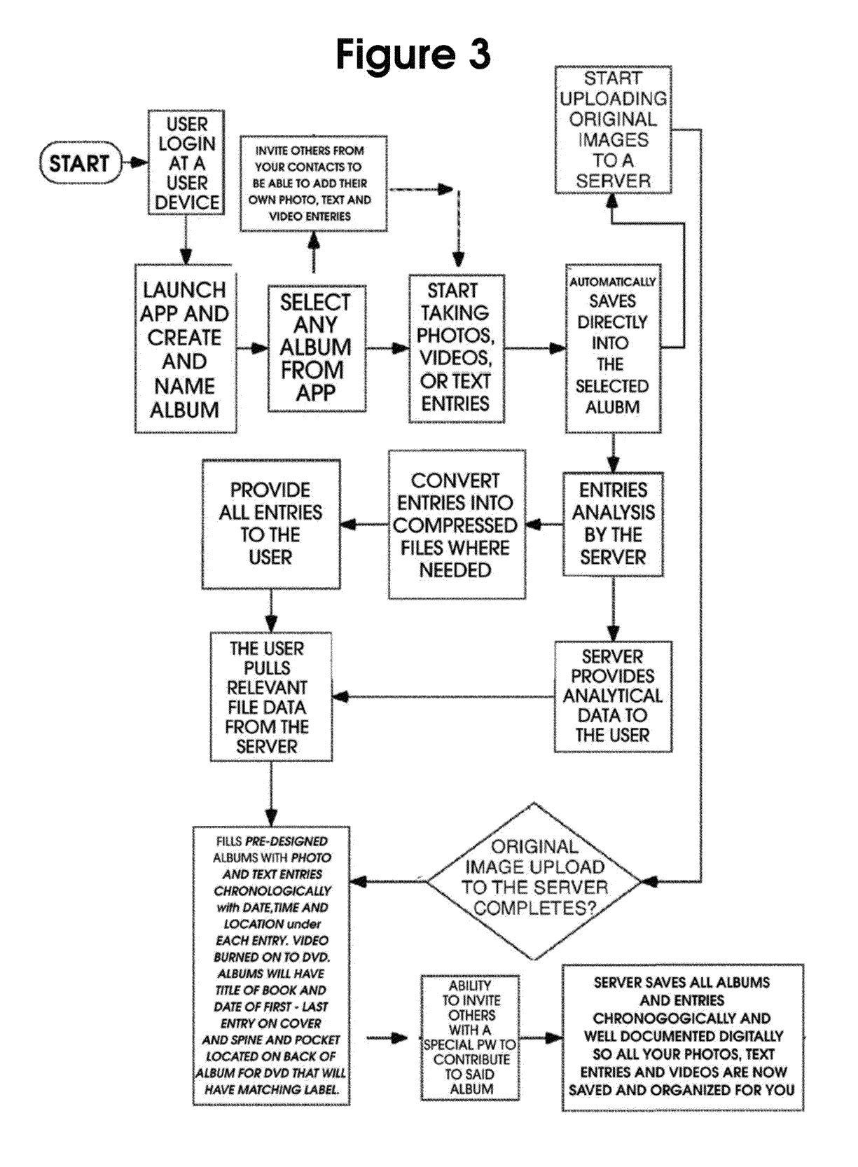

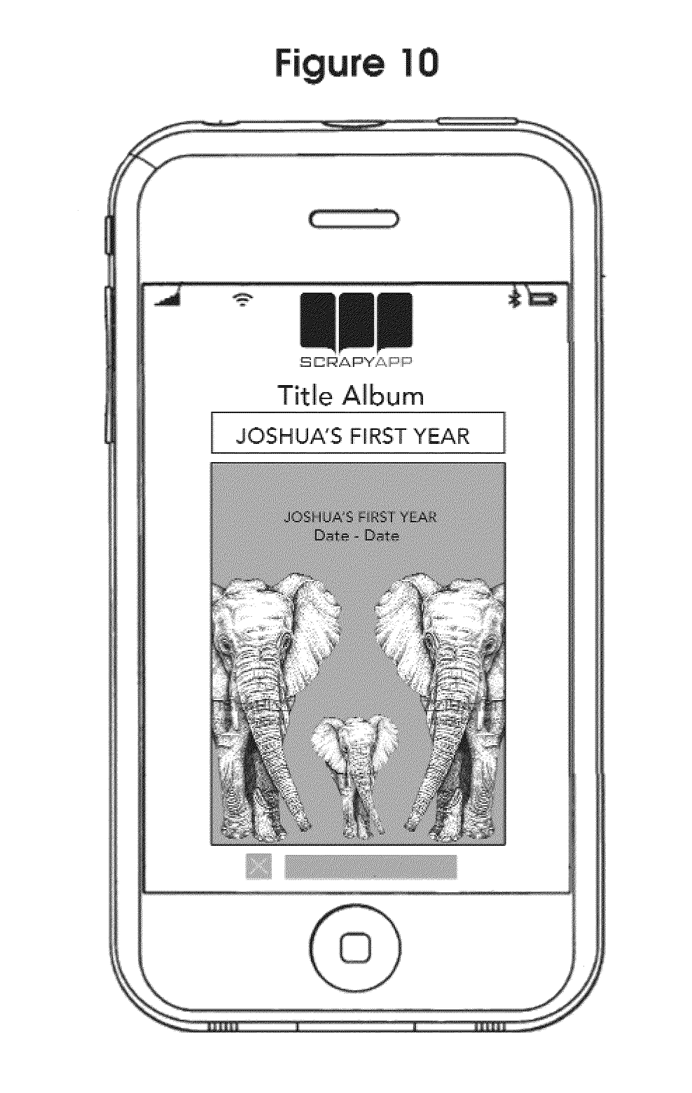

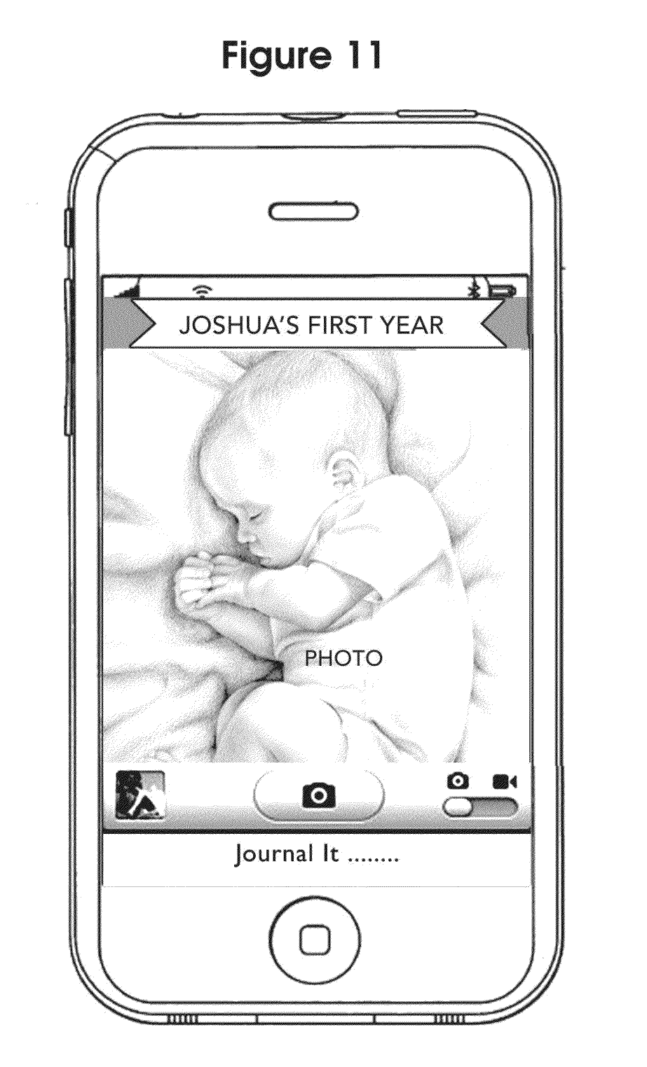

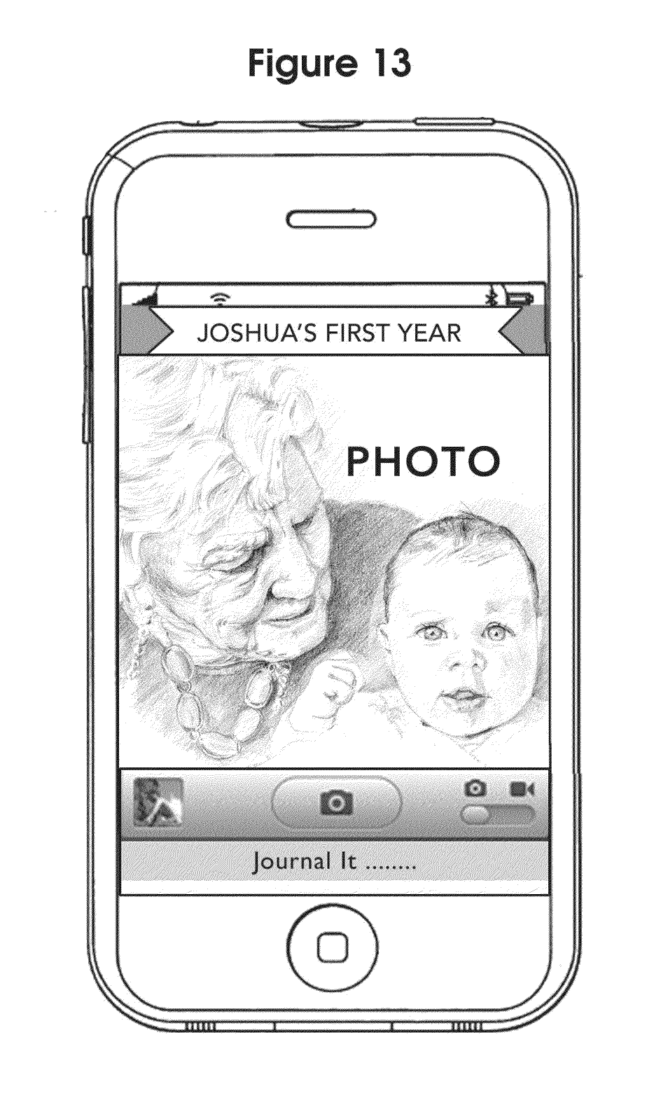

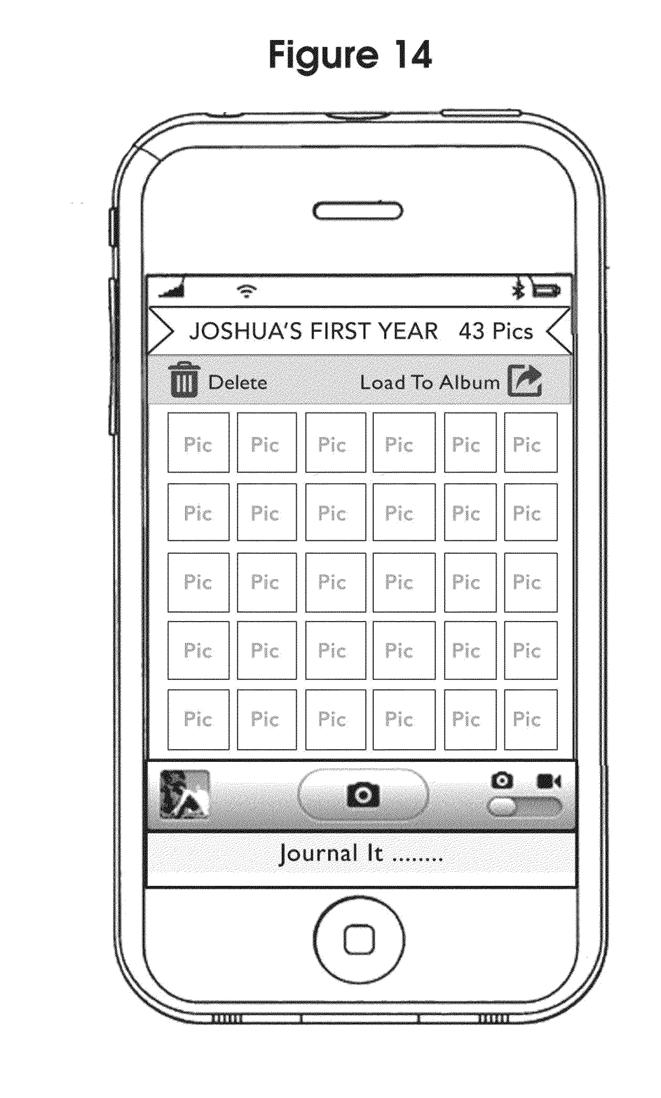

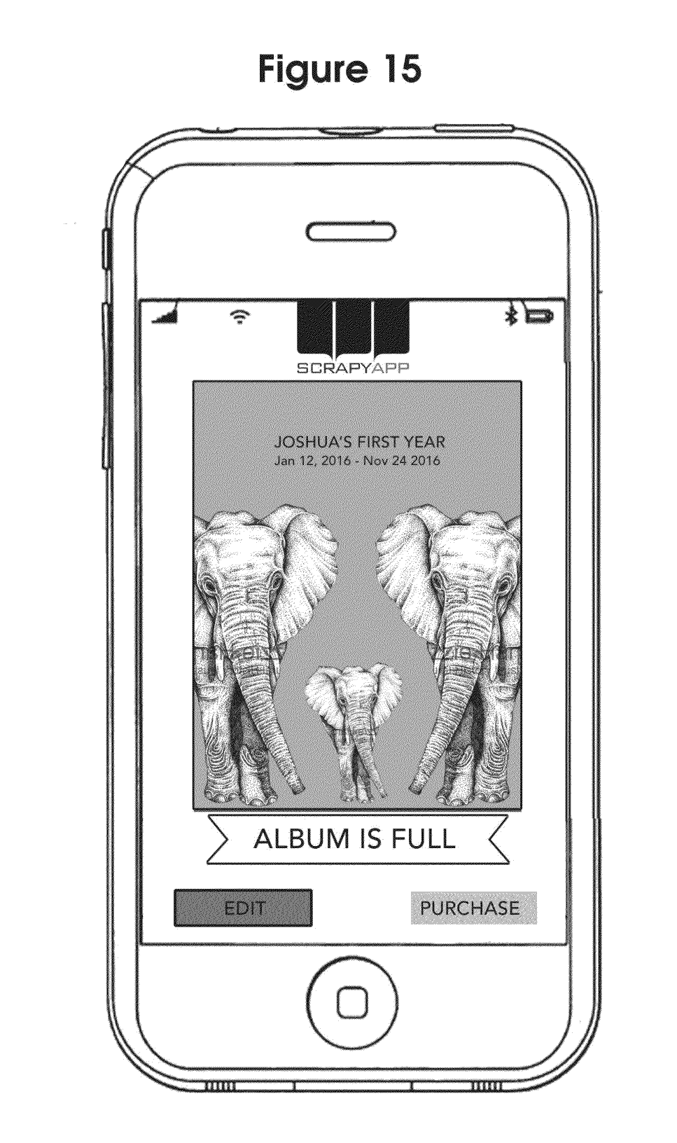

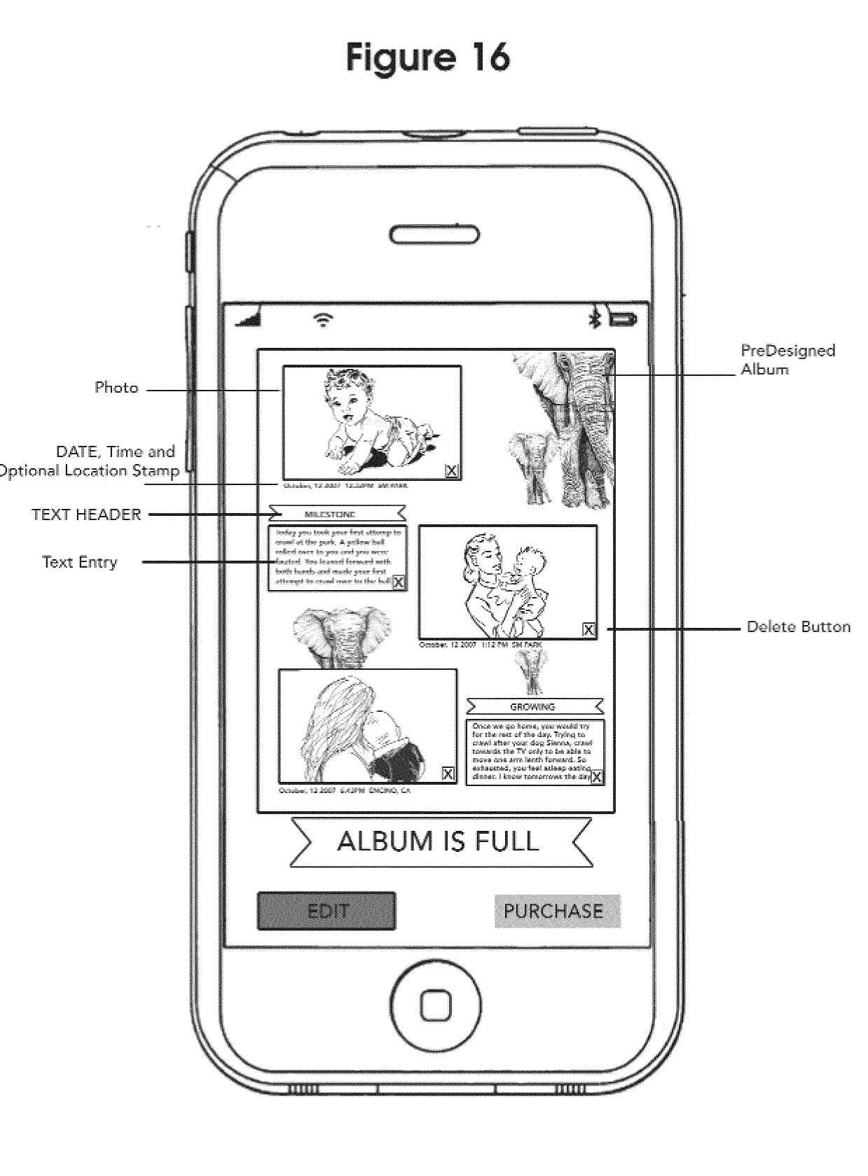

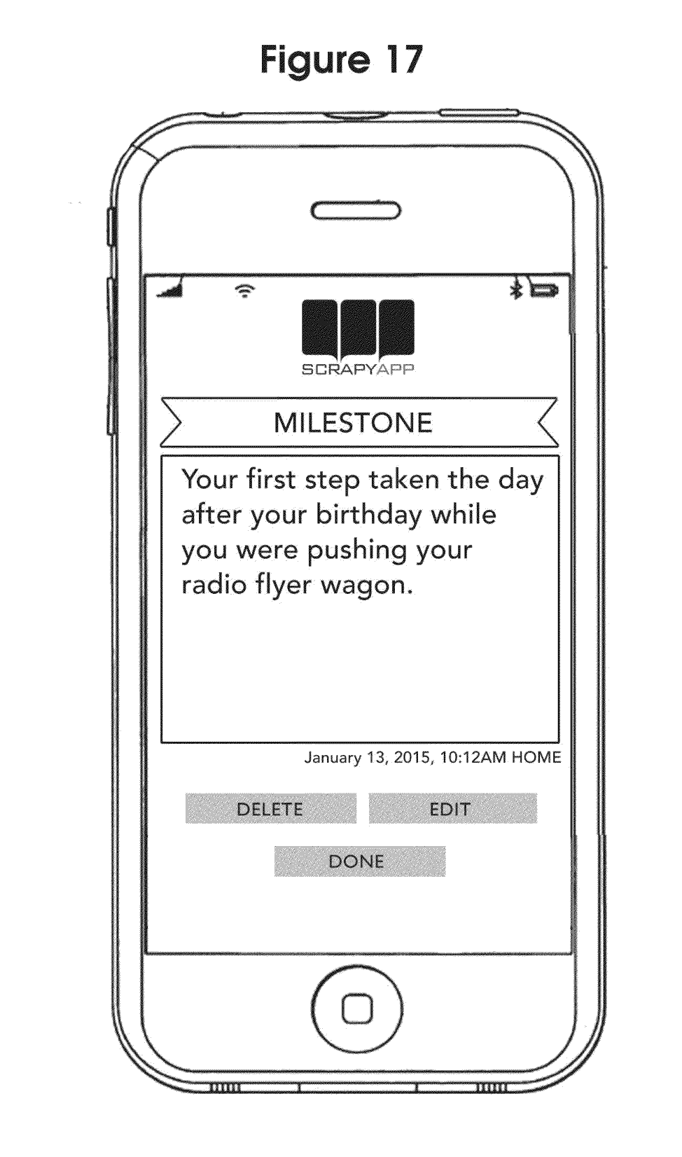

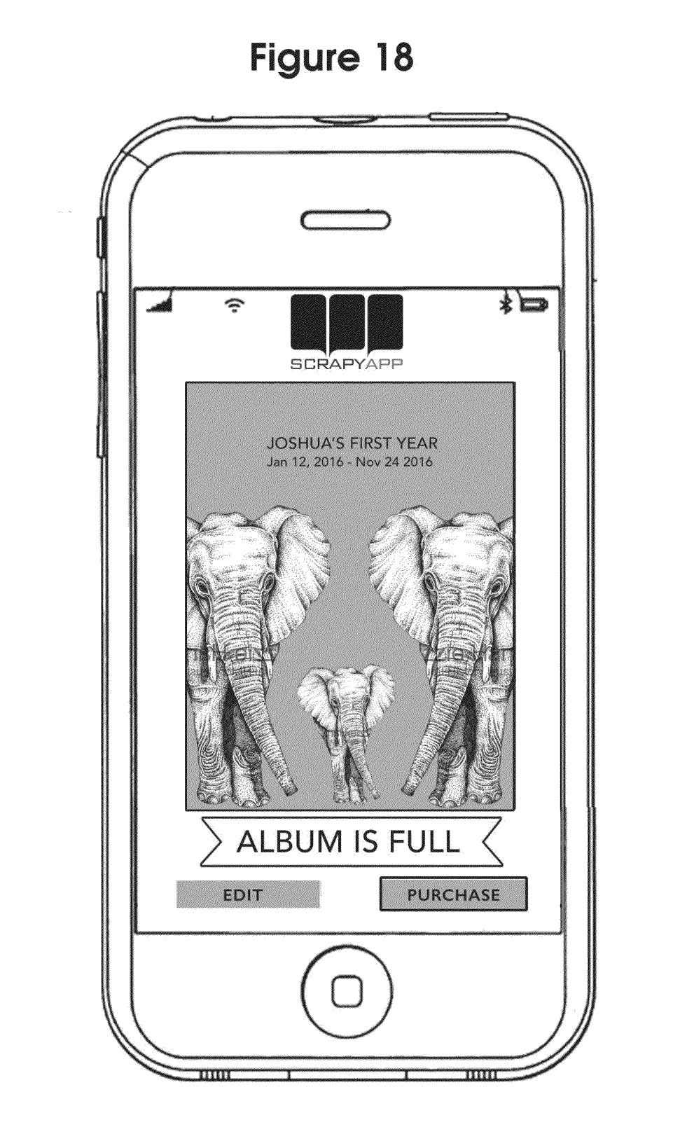

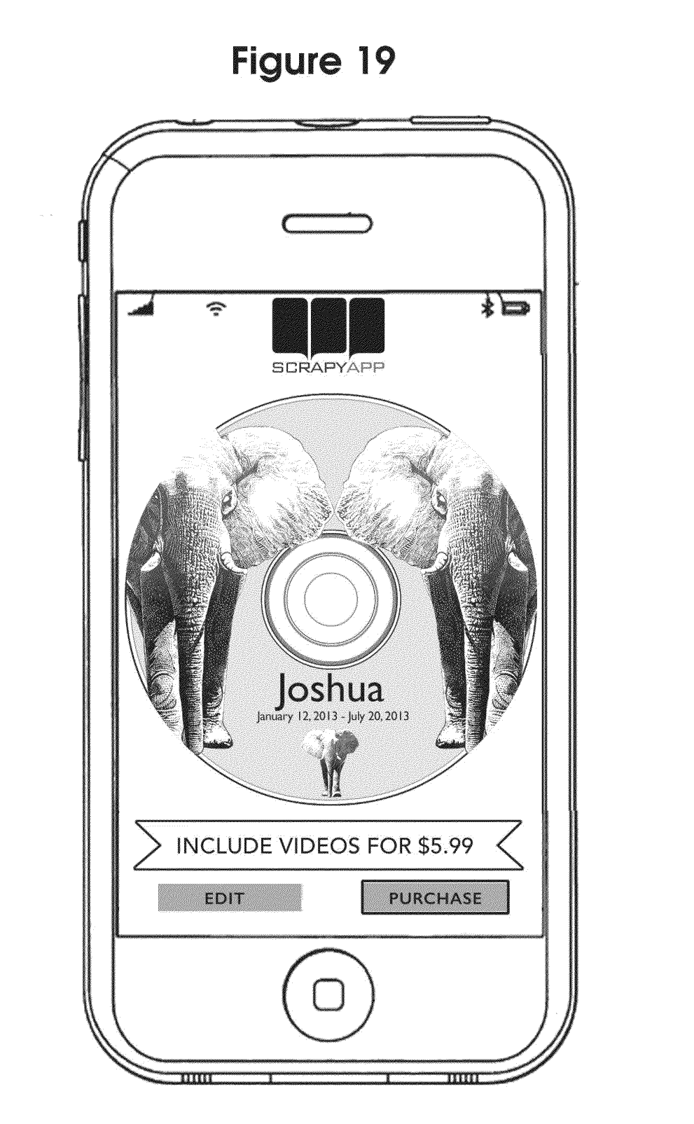

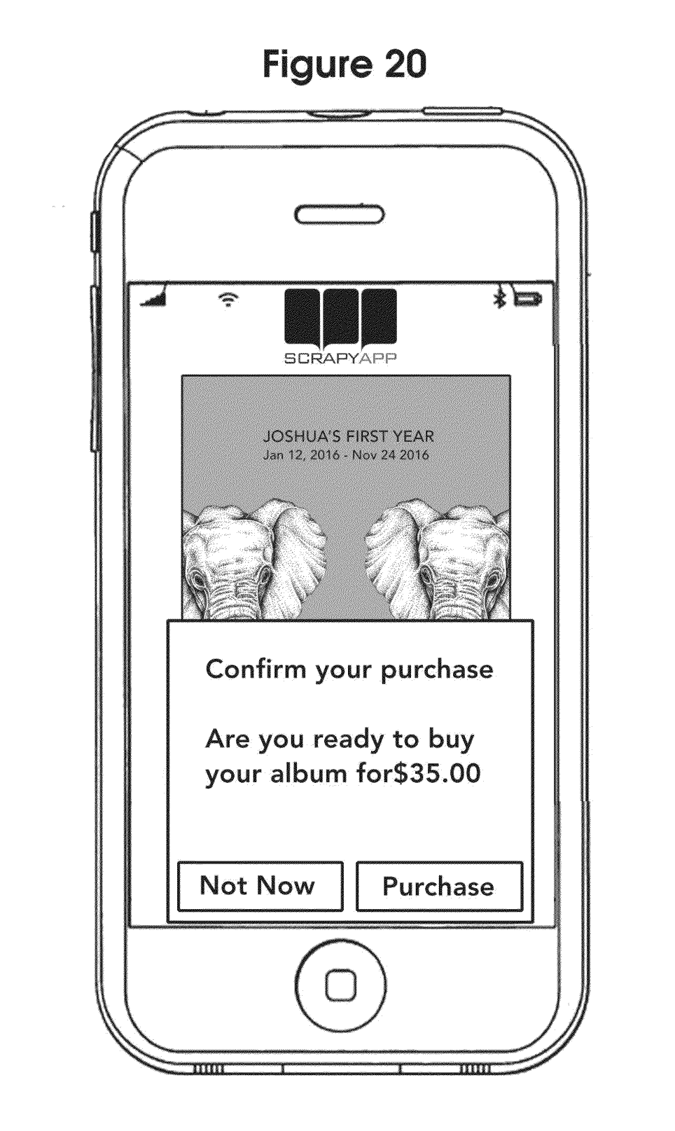

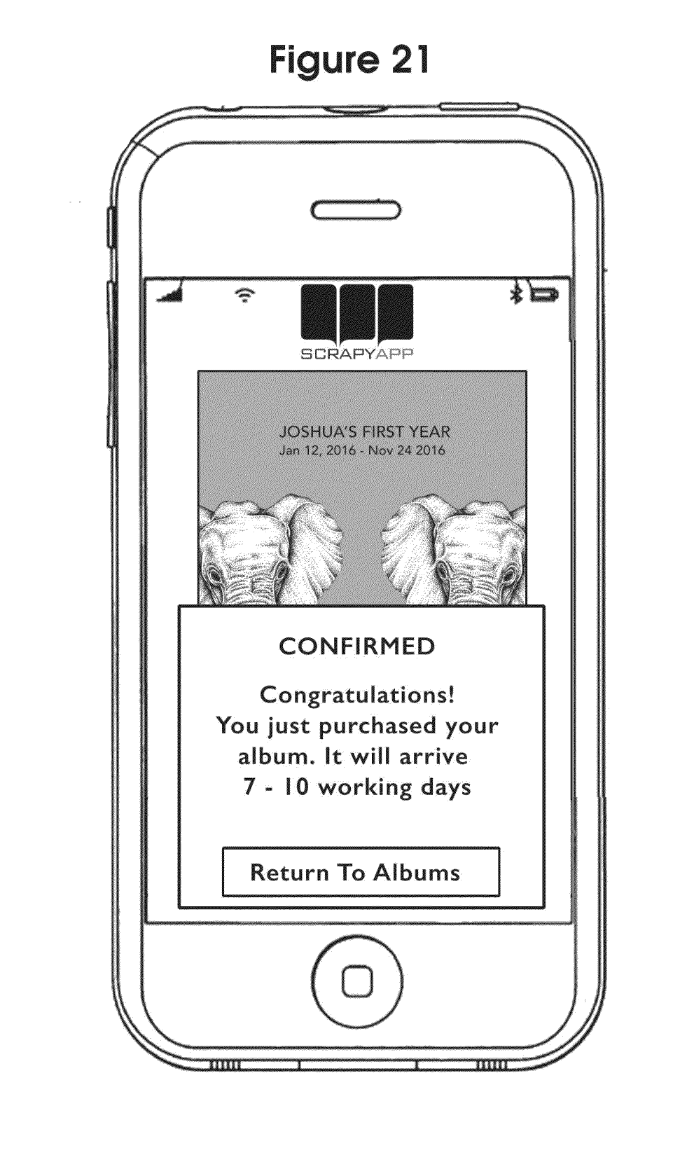

A method of using the present invention, on an electronic device, is shown in FIG. 3. FIG. 4 shows the program or application installed on a smartphone. The first step a user takes is creating an account, as shown in FIG. 5. Once an account has been created, the user is then able to create a photo album, as shown in FIG. 6. After a photo album has been created, the user can then invite other users to access the photo album, as shown in FIG. 7. The next step is selecting an album style, as shown in FIG. 8. An exemplary album style for boys from ages of 0-8 years of age is shown in FIG. 9. Once the album style has been selected, the user can then create a title for album, as shown in FIG. 10. Then the user can begin uploading photos to the photo album, as shown in FIG. 11. Next, the user can create a customized caption and heading to accompany the photo, as shown in FIG. 12. The user also has the ability to upload movies to the album, as shown in FIG. 13. FIG. 14 shows a completed photo album. If an album is full, the user has the option to edit or purchase the album, as shown in FIG. 15. The use of the edit option is shown in FIG. 16. The user can also create a “Milestone” in the album, as shown in FIG. 17. The Milestone can be accompanied by a custom caption. The option of purchasing the entire album is shown in FIG. 18. Next, as shown in FIG. 19, the user is presented with the option of purchasing videos of the selected album. Then, when the user selects the option of purchasing the entire album, a confirmation page is displayed providing the user with the total cost for purchasing the entire album, as shown in FIG. 20. Finally, as shown in FIG. 21, a final confirmation page is shown providing the user with the anticipated arrival time for the purchased album.

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure. All references cited herein are incorporated by reference in their entirety.

What is claimed is:

1. A method for automatically creating a photo album, the method comprising the steps of:
a) selecting a pre-designed photo album template, the photo album template comprising one or more pages of the photo album;
b) automatically and chronologically stamping a plurality of images in one or more pages of the photo album within the photo album template;
c) adding image and metadata associated with the plurality of images to the one or more pages of the photo album; and
d) storing a completed photo album on a storage media.

2. The method of claim 1, wherein the photo album template comprises a theme to accommodate a preset number of photos or a preset number of photo album pages and journal entries.

3. The method of claim 1, wherein the plurality of images comprises one or more photographs or one or more videos.

4. The method of claim 1, wherein the storage media comprises one or more non-writable storage media, writable storage media, communications media, or a combination thereof.

5. The method of claim 1, further comprising step e) sharing the photo album with one or more users, wherein step e) follows step c).

6. The method of claim 1, wherein a plurality of photo albums are automatically created simultaneously.

7. A method of creating a photo album, the method comprising the steps of:
a) creating a user account on a device;
b) creating one or more photo albums from a predetermined template in the user account;
c) saving a plurality of photographs to the one or more photo albums;
d) adding one or more text entries to the one or more photo albums;
e) adding one or more video entries to the one or more photo albums;
f) automatically organizing the plurality of photographs, the one or more text, and the one or more video entries to the one or more photo albums chronologically and in real time as the event is occurring;
g) automatically uploading the one or more photo albums to a server; and
h) printing the one or more photo albums at a predetermined time.

8. The method of claim 7, further comprising step i) editing the photo album.

9. The method of claim 8, wherein step i) comprises editing the text entries.

10. The method of claim 8, wherein step i) comprises editing the one or more photos in the one or more photo albums.

11. The method of claim 8, further comprising step j) sharing the photo album with one or more users.

12. A method of creating a photo album, the method comprising the steps of:
a) creating a user account on a device;
b) creating one or more photo albums from one or more predetermined templates in the user's account;
c) saving a plurality of photographs to the one or more photo albums;
d) editing one or more photos in the one or more photo albums;
e) adding one or more text entries to the one or more photo albums;
f) editing the one or more photos in the one or more photo albums;
g) adding one or more video entries to the one or more photo albums;
h) automatically organizing the plurality of photographs, the one or more text entries, and the one or more video entries to the one or more photo albums chronologically and in real time as the event is occurring;
i) storing the photo albums on non-writable storage media, writable storage media, communications media, or a combination thereof;
j) automatically uploading the one or more photo albums to a server; and
k) printing the one or more photo albums at a predetermined time.
